(19) United States
(12) Patent Application Publication
(10) Pub. No.: US 2013/0219299 A1
(43) Pub. Date: Aug. 22, 2013

(54) LIVE BAR

(71) Applicant: Gface GmbH, (US)

(72) Inventor: Cevat Yerli, Frankfurt/Main (DE)

(73) Assignee: GFACE GMBH, Frankfurt/Main (DE)

(21) Appl. No.: 13/749,605

(22) Filed: Jan. 24, 2013

Related U.S. Application Data
(60) Provisional application No. 61/599,897, filed on Feb. 16, 2012.

(51) Int. Cl. G06F 3/0481

(52) U.S. Cl. CPC G06F 3/0481
USPC 715/753

(57) ABSTRACT

A described method comprises: displaying a browser window on a display device, wherein said browser window is adapted to display live content and current activities of said user in relation to said live content; detecting user input in relation to the displayed live content and/or activity, wherein the user input includes dragging the live content and/or current activity from the browser window and dropping it in at least one slot of a sidebar of said browser window; creating a new slot associated with a current activity to be displayed on said sidebar, if the current activity was dropped in a dedicated slot of the sidebar; displaying the new slot on the sidebar; tracking changes inside the activity associated with an existing slot; modifying the existing slot in the sidebar based on changes inside the activity associated with the existing slot; and displaying the modified slot in said sidebar.

### CROSS-REFERENCE TO RELATED APPLICATION

This application claims the benefit of U.S. Provisional Patent Application No. 61/599,897, filed Feb. 16, 2012, the disclosure of which is incorporated by reference herein in its entirety.

### TECHNICAL FIELD

The present invention relates to a method for displaying a sidebar on a browser window.

### BACKGROUND

On a computer system including input devices, output devices, and an interface for connecting the computer system to a computer network, a user typically handles a plurality of applications on a graphical interface, such as a browser window. Some of the applications may refer to live content received via the network and to users' activities in connection with the live content received via the network.

However, due to the limited space on the user's graphical interface or browser window, it is often not possible to display all activities and online contents simultaneously in the browser window. Thus, the visibility to the user of all activities and online content of the browser windows is limited.

An effort to enhance the visibility of multiple applications in a user interface was made by providing a sidebar showing items associated with applications which are currently not presented on the graphical user interface.

U.S. Pre-Grant Publication No. 2006/0112348 A1 discloses a multiple-mode window presentation system for managing the presentation of windows on a display screen of a computing device. Elements of the graphical user interface are displayed on a task bar or sidebar in the appearance mode when the window is maximized.

U.S. Pre-Grant Publication No. 2006/0123353 A1 discloses a method and a system of task bar button interfaces. The task bar includes a rich presentation task bar button for displaying and/or dismissing a thumbnail of an application window associated with the rich presentation task bar button. The rich presentation task bar button comprises a display element authored by an application. The display element may comprise dynamic information such as securities information, news event information, instant messaging information, and application status information.

However, the user's flexibility to organize simultaneous activities in browser windows is still limited, as the information displayed in a task bar cannot be dynamically adapted by the user. Moreover, the present systems are not dedicated to organizing activities in connection with a variety of online content, such as in a social network.

Thus, there is a need in the art for a method and a system that helps a user to organize simultaneous activities, in particular simultaneous activities in connection with (but not exclusively for) social networks.

### SUMMARY

The present disclosure relates to a method for displaying a sidebar on a browser window, and, in particular, to a sidebar (which also may be referred to as a “live bar”) associated with current activities and live content displayed in the browser window.

Moreover, the present disclosure relates to a computer program and, in particular, to a computer program adapted to perform the method of displaying a live bar on a browser window.

A first aspect of the present disclosure provides, in a computer system having a user input device, a display device, and at least one interface for connecting the computer system to a computer network, a method of displaying a sidebar on a browser window, said method comprising the steps of:
displaying a browser window on the display device, wherein said browser window is adapted to display live content received from said network and current activities of said user in relation to said live content;
detecting user input in relation to the displayed live content and/or activity, wherein the user input includes dragging the live content and/or current activity from the browser window and dropping it in at least one slot of a sidebar of said browser window;
creating a new slot associated with a current activity to be displayed on said sidebar, if the current activity was dropped in a dedicated slot of the sidebar;
displaying the new slot on the sidebar;
tracking changes inside the activity associated with an existing slot;
modifying the existing slot in the sidebar based on changes inside the activity associated with the existing slot; and
displaying the modified slot in said sidebar.

The sidebar offers a visual anchor for all live content and current activities of the user, e.g., in a social network. Moreover, the system keeps track of changes inside the content and activities and displays them accordingly. Thus, the sidebar helps the user to organize simultaneous activities in relation to live content even if the activities are not currently displayed in the browser window.

The user's activity may include at least one of text chats, video chats, online or offline game sessions, notification applications, and media content playback applications.

The live content may include at least one of media content received via the network, notifications received via the network, and icons of users connected to said network.

According to an embodiment, if the user input includes dragging live content from the browser window and dropping it into an existing slot in the sidebar, then the method further comprises adding the online content to the activity associated with said existing slot. Hence, the user may add any live content to an existing activity which is already displayed in a slot of the sidebar, even if the activity is not presently shown in the browser's window.

According to an embodiment, if the user input includes dragging of an icon associated with another user connected to said network from said browser window and dropping it to an existing slot in said sidebar associated with a text chat, video chat, or online game session; then the method further includes sending a notification via the network to the other user to be invited to said text chat, video chat, or online game session, respectively. Thus, the users may communicate with other users via an activity of the browser's window even if the activity is not currently displayed in the browser window.

According to an embodiment, the method may further comprise displaying an expanded slot when said slot is selected by user input; and/or displaying a minimized slot when an icon connected to said slot is selected by user input. The expanded slot may display the user's activity or the online content in its usual size for active use. The minimized slot may comprise a shortcut of the online content or the activity associated with the slot.

According to an embodiment, the method may further comprise scrolling in a plurality of slots of said bar when an icon on at least one end of said sidebar is selected by user input. Moreover, the icon on one or both ends of the sidebar may include a number of hidden slots on the respective end of the bar. Thus, the user may easily scroll in the sidebar even if not all slots are displayed in the sidebar.

According to an embodiment, a number in a slot indicates a number of new messages received in the activity associated with said slot and not yet displayed on the browser window. Moreover, a number in an icon on at least one end of the bar may indicate number of new messages received in any of the activities and/or live content associated with all hidden slots at the respective end of the sidebar.

The method may further comprise displaying an enlarged slot when the user moves or hovers a pointing device over said slot. Moreover, when the user hovers or moves the pointing device over the slot, the slot may show further information about the activity associated with the slot. The information may, e.g., include the users participating in a chat or game session associated with the slot.

When the user selects a slot displayed in the sidebar, such as a double click by a pointing device, the activity associated with the slot may be shown in an expanded window in the browser window.

According to a representative embodiment, if the user selects an activity or live content displayed on the browser window, hiding those slots of the displayed slots of the sidebar where the selected activity or content cannot be docked. Moreover, if the user tries to drop content or an activity to a non-allowed slot, a warning is displayed in said slot. This functionality helps the user to anchor activities or live content to existing slots of the sidebar that the user can directly see after selecting the activity or the live content to anchor to the slots.

In an embodiment, if a user's action is requested by an activity associated with a slot displayed in the sidebar, the method comprises highlighting said slot in the sidebar. Thus, the user is kept informed of these activities even if they are not currently displayed in the browser window.

A further aspect of the disclosure provides computer-readable medium (e.g., a storage medium) having stored thereon a computer program including computer-readable instructions that, when executed on a computer system, performs any method as previously disclosed.

### DESCRIPTION OF THE DRAWINGS

The specific features, aspects and advantages of the present disclosure will be better understood with regard to the following description and accompanying drawings where:

FIGS. 1 to 23 are images of a display screen showing a browser window including a sidebar in different situations, according to one or more embodiments.

### DETAILED DESCRIPTION

In the following description, reference is made to the drawings which show, by way of illustration, specific embodiments. It is to be understood that the embodiments may include changes in design and structure without departing from the scope of the claimed subject matter.

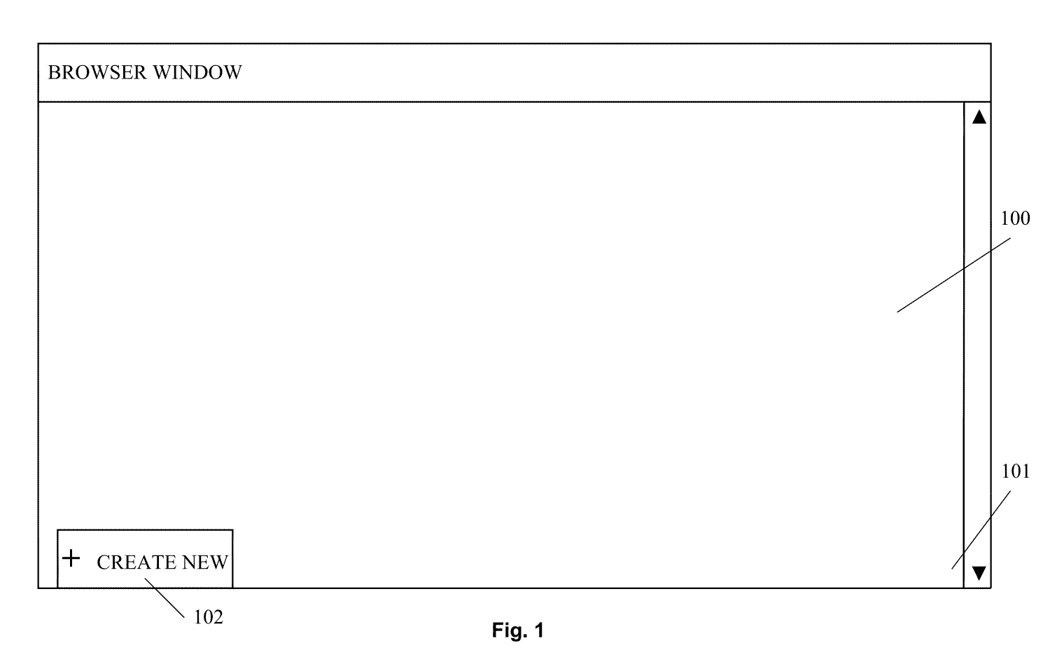

A typical browser window in accordance with the present disclosure is shown in FIG. 1. The browser window presents a user interface for participating in a social network. The browser window includes a field 100 (in the example of FIG. 1, the field 100 is empty) which is adapted for displaying online content received from the network and a user's activity, i.e., application programs, in relation to the online content. Such activities may be, e.g., video chats, text chats, online gaming, etc. The browser window includes a sidebar 101 which, in the present example, is a bar on the bottom of the browser window. In the sidebar of FIG. 1, only one slot is visible, the “create new” slot 102. The sidebar 101 also can be referred to as a “live bar.”

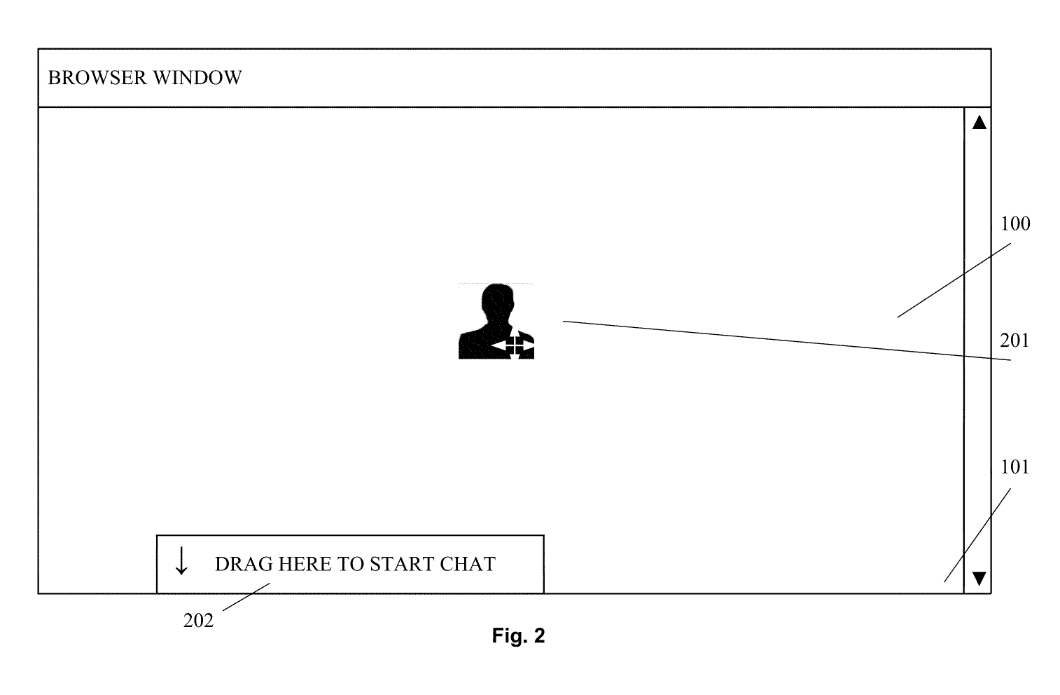

The user may drag an icon 201 of another user (see FIG. 2), who is online in the social network, to the “create new” slot. Then, the system automatically creates a chat with said user. When the user's icon is selected, as shown in FIG. 2, the “create new” slot changes to a slot 202 showing the text “drag here to start chat.”

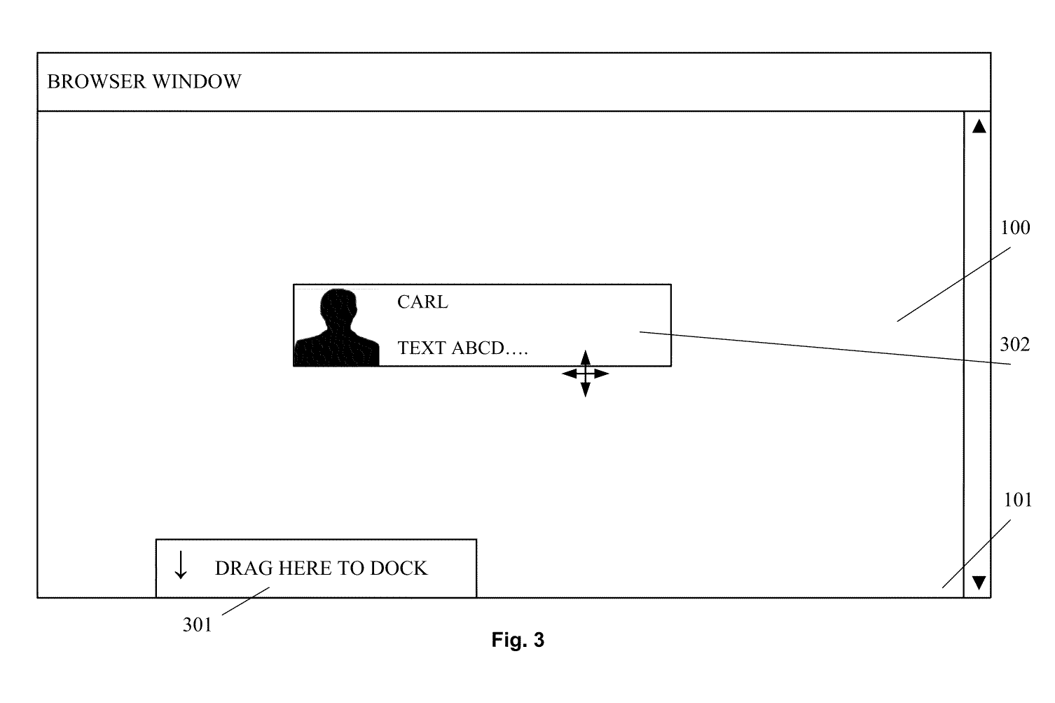

If an existing chat 302 is presented in the field 100, as shown in FIG. 3, a user may drag the existing chat to the “create new” slot. When the existing chat is selected, the “create new” slot shows the text “drag here to dock” 301 as shown in FIG. 3.

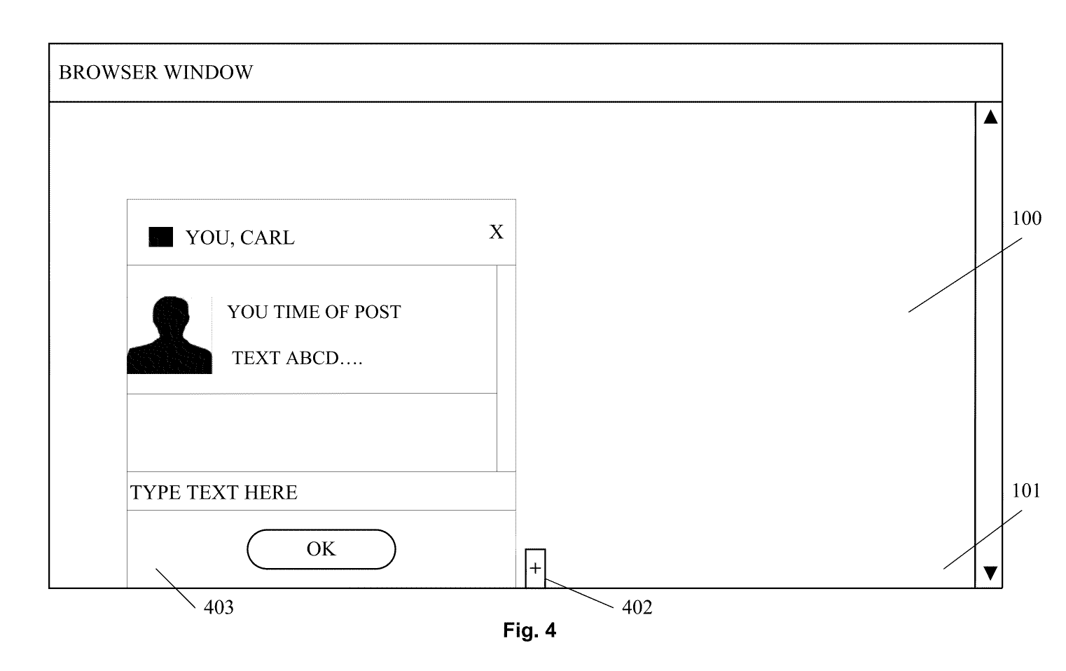

FIG. 4 shows a docked chat 403 on the sidebar 101 in an expanded state. In the expanded state, chat text is presented and the user may input chat messages. Next to the slot a “+” icon 402 appears, which is a minimized “create new” slot that appears in the moment the sidebar is not used, i.e., if a pointing device is not hovering over the live bar.

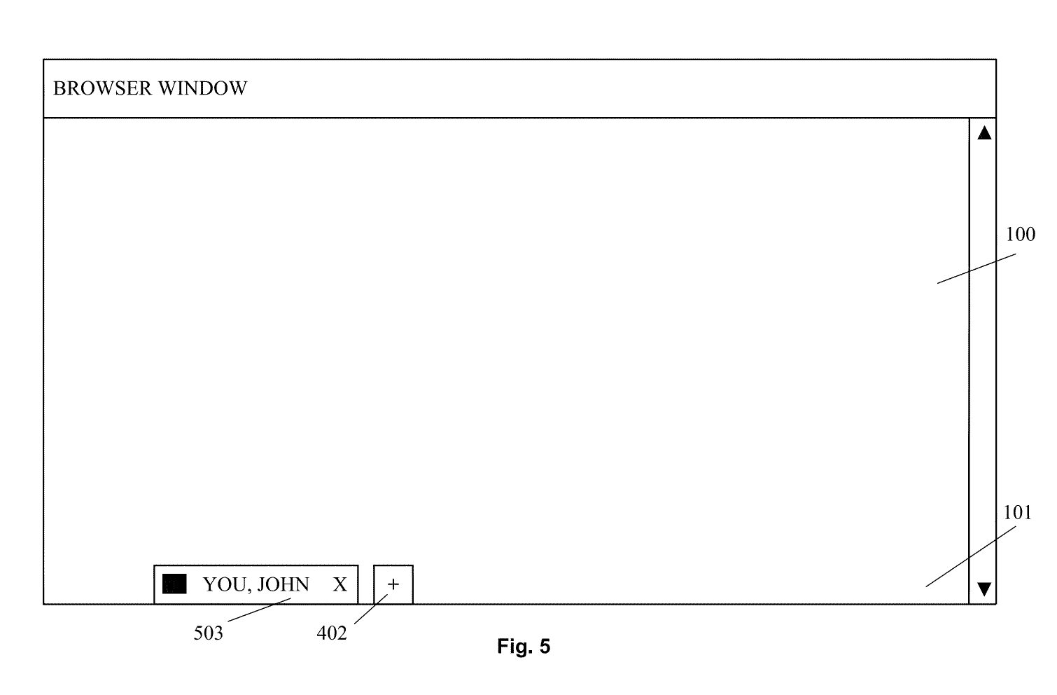

Upon a user interaction with an “x” symbol of the chat slot 403 in the expanded state, the slot is minimized to slot 503, as shown in FIG. 5.

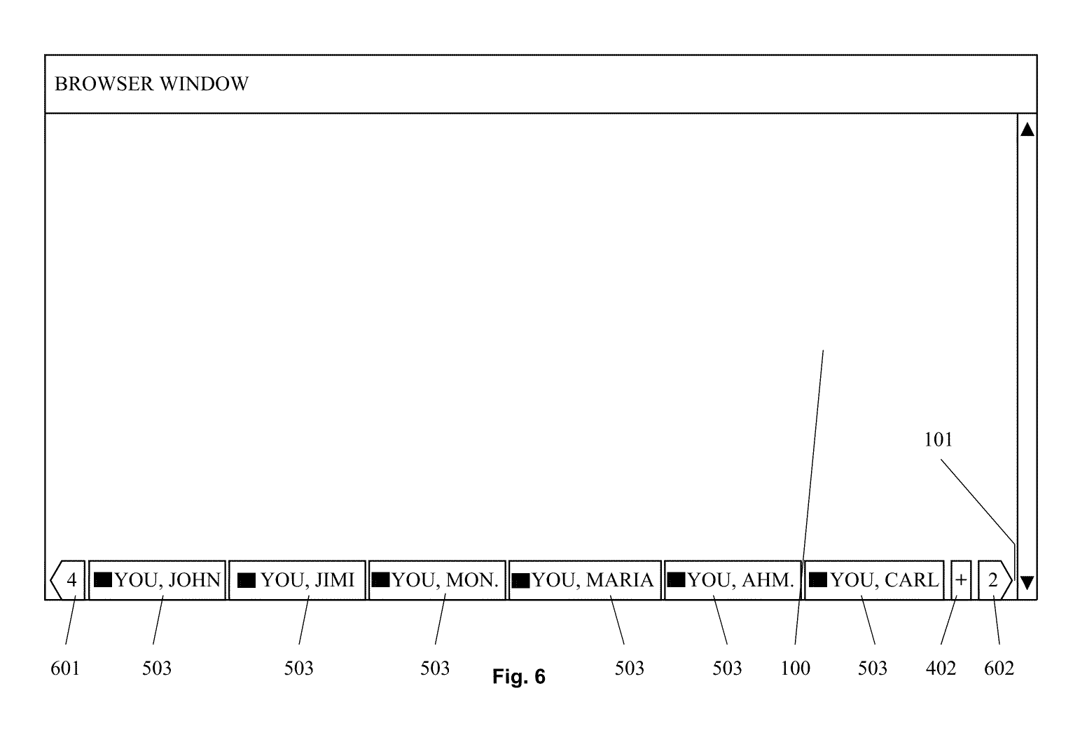

FIG. 6 shows a plurality of chat slots 503 in the minimized state. Moreover, on the left side and the right side of the sidebar 101, icons 601 and 602 are presented which allow scrolling along slots of the sidebar which are not currently presented. Moreover, each of the icons 601 and 602 shows a count which represents a number of hidden slots on the respective end of the sidebar.

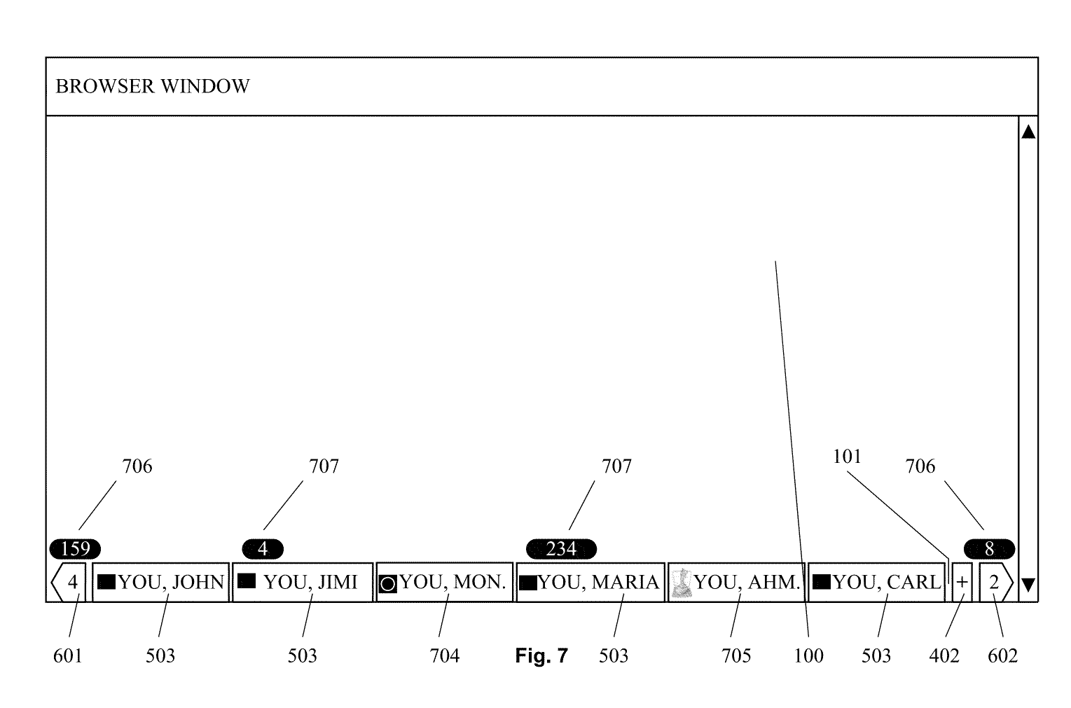

FIG. 7 shows a plurality of collapsed chat slots 503. Moreover, the sidebar 101 includes a collapsed video chat slot 704 and a collapsed game session slot 705. Several different icons appear in the different types of collapsed slots to indicate the type of slot, i.e., text chat, video chat, or game session. On some of the collapsed slots, an indicator 707 indicates how many messages are uploaded that the user has not yet seen. Also on the “move to the left” icon 601 and the “move to the right” slot 602, an indicator 706 indicates how many messages are uploaded on all hidden slots of the respective end that the user has not seen yet. It should be noted that the icons and the slots are merely examples, and can change according to the actual details of different embodiments.

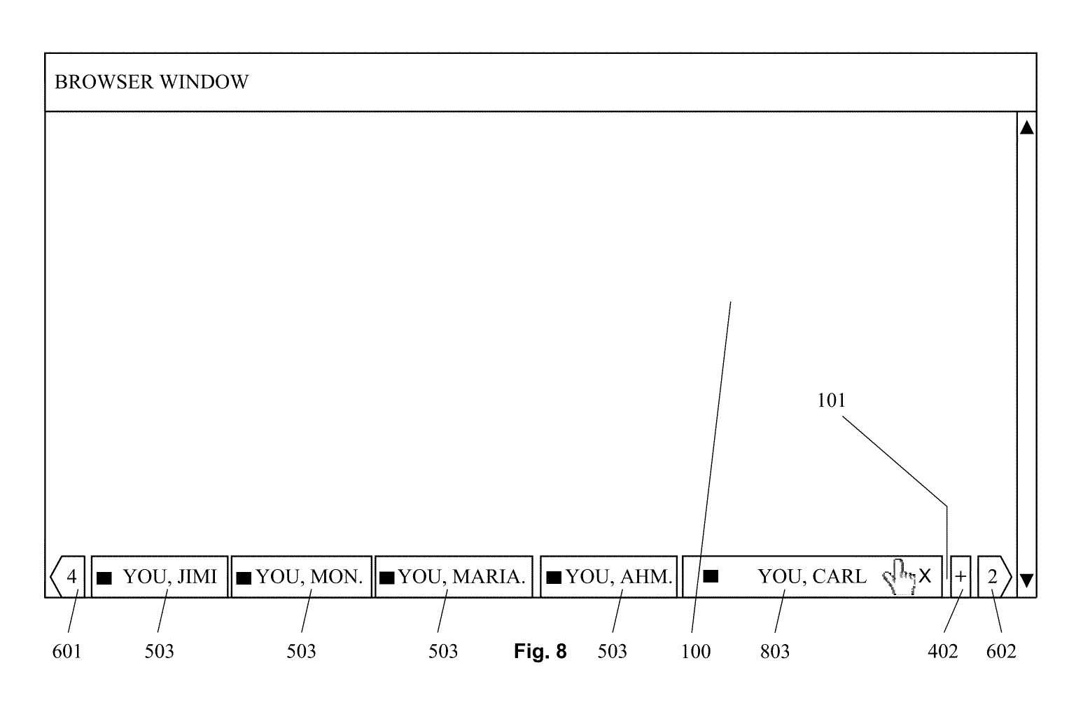

FIG. 8 shows a pointing device hovering over one of the slots 803. The slot 803 automatically enlarges on the sidebar. Moving the pointing device away shrinks the slot 803 again to collapsed slot 503.

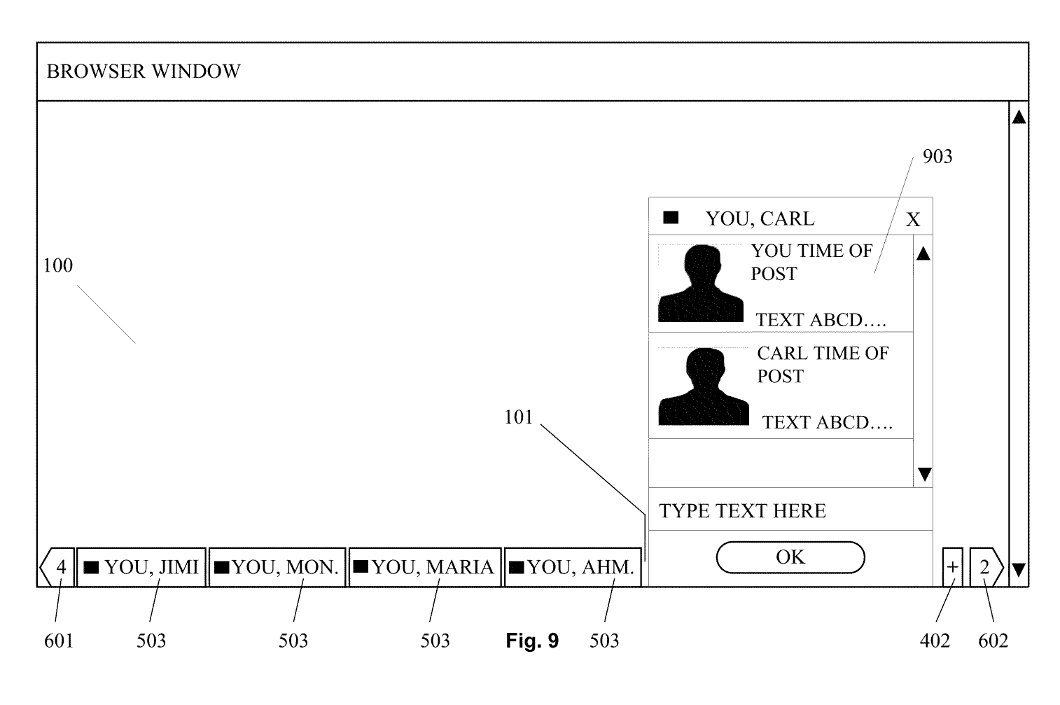

If the user clicks on a slot, the slot expands to its usual size for active use, as shown in FIG. 9, which shows an expanded chat slot 903. The expanded slot stays attached to the sidebar.

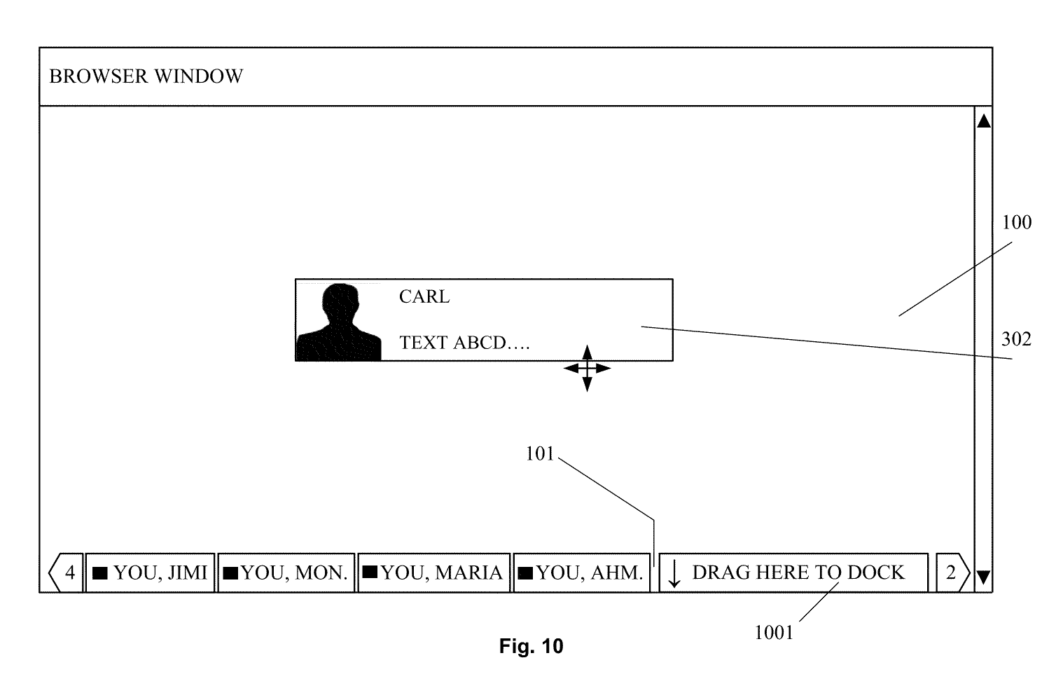

To create a new chat with the user in a filled-up sidebar 101, the user may drag a chat window 302, as shown in FIG. 10, to the “create new” slot. Upon selection of the chat window 302 with the pointing device, the “create new” slot appears as a “drag here to dock” slot 1001, as shown in FIG. 10. The sidebar automatically enlarges the slot 1001 to the right, showing the user where the dragged window 302 can be moved to be attached to the sidebar.

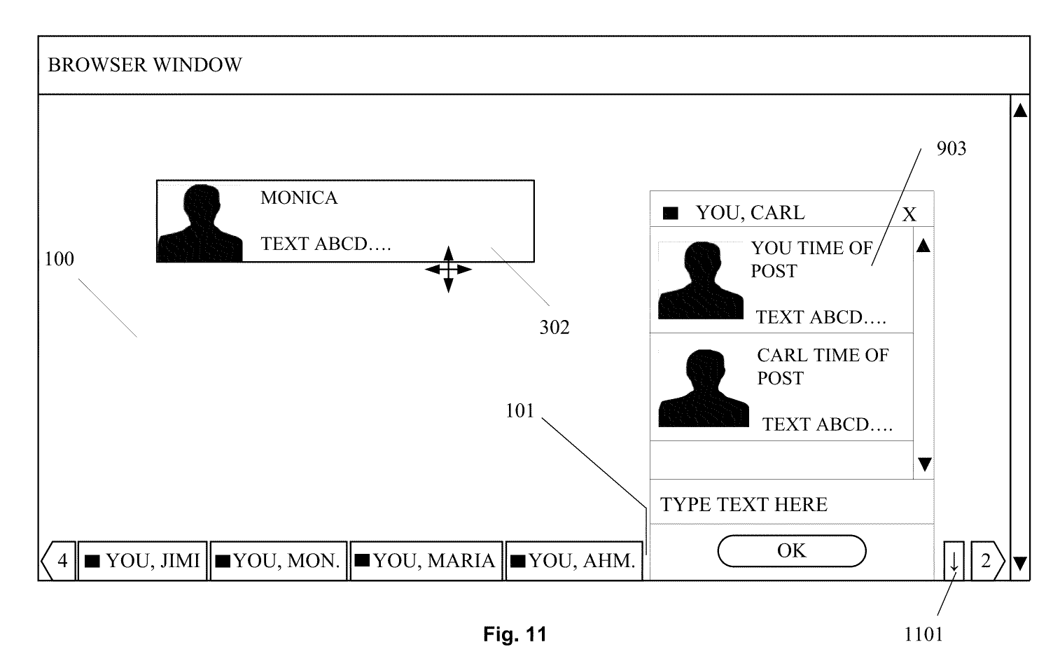

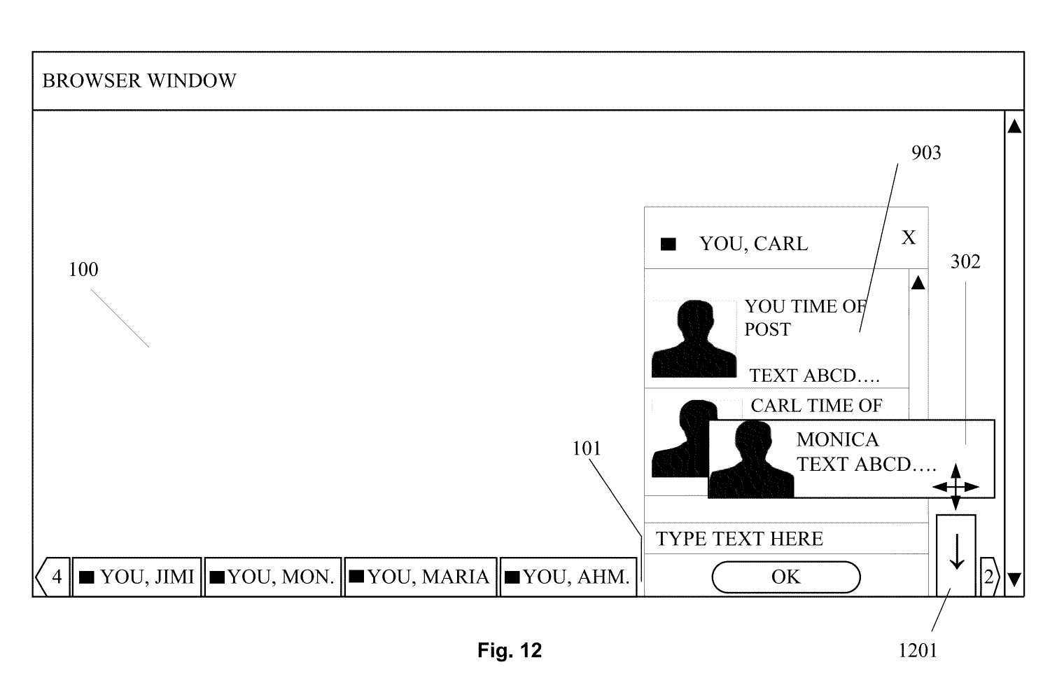

FIGS. 11 and 12 show docking a chat to the sidebar while another chat is still open. If the user starts dragging the chat window 302 across the screen, when one chat 903 is still open, the user can dock it into a new chat slot by dragging it to the slot 1101 (indicated by a downward arrow) of the sidebar. When the chat window 302 is moved across the screen, the slot 1101 is increased in size, as shown by slot 1201 in FIG. 12, indicating to the user that the chat window is allowed to dock on the slot.

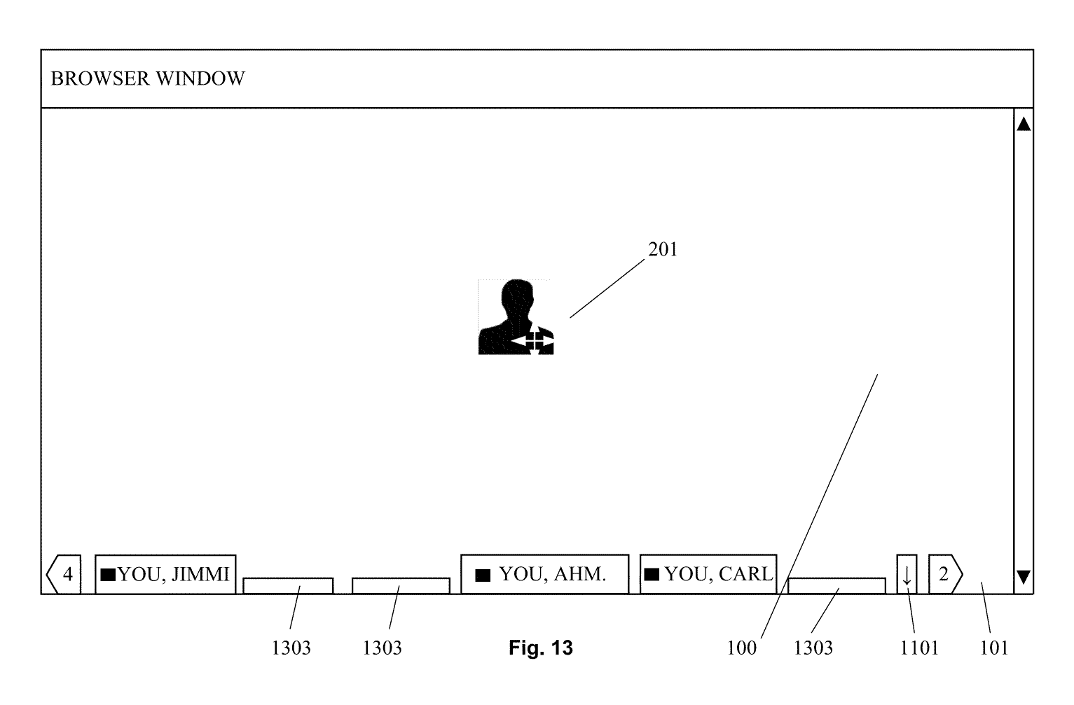

The user can drag another user's icon 201, as shown in FIG. 13, to the sidebar. The sidebar will automatically hide those slots 1303 where the dragged user cannot be docked.

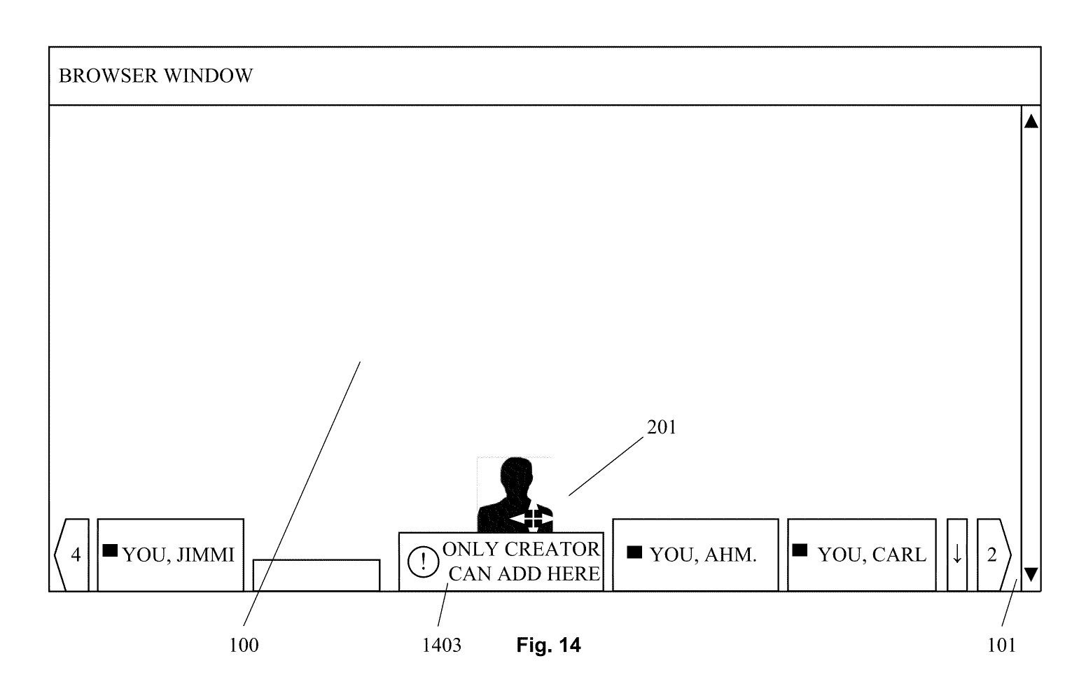

If the user, nevertheless, tries to drop a user icon 201 onto a slot where it cannot be docked on the sidebar, the sidebar shows a warning 1403, indicating that only the creator of the slot can actively add/drop other users onto said slot, as shown in FIG. 14.

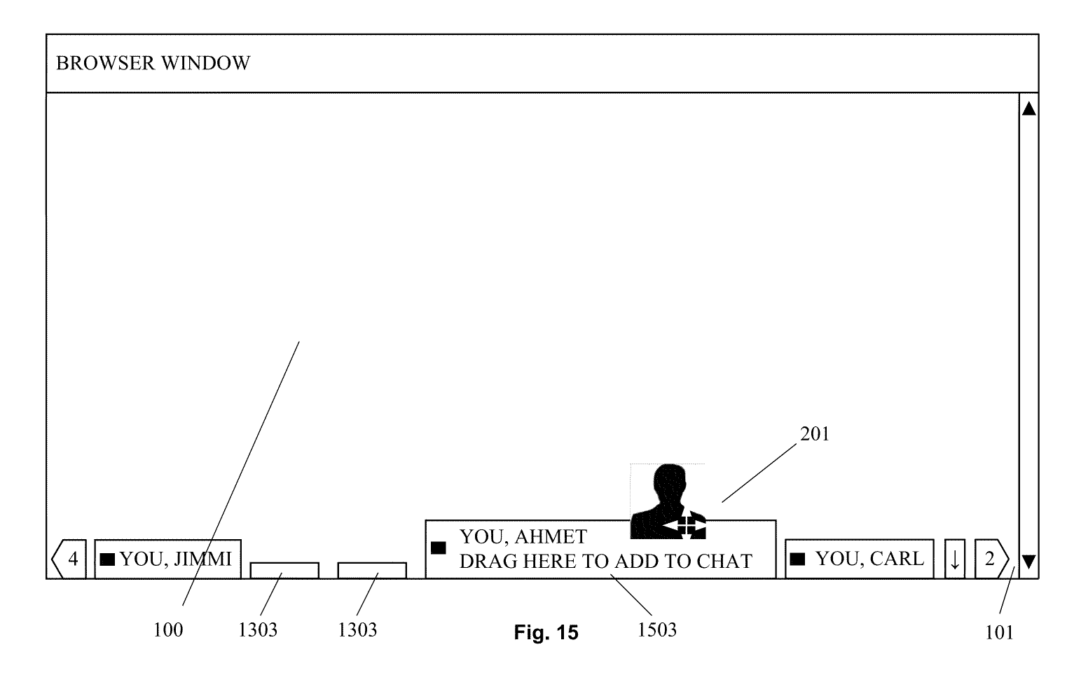

If the user moves a user icon 201 onto a slot where the icon can be dropped, the sidebar 101 indicates that the action is permitted by an increased chat slot 1503, as shown in FIG. 15.

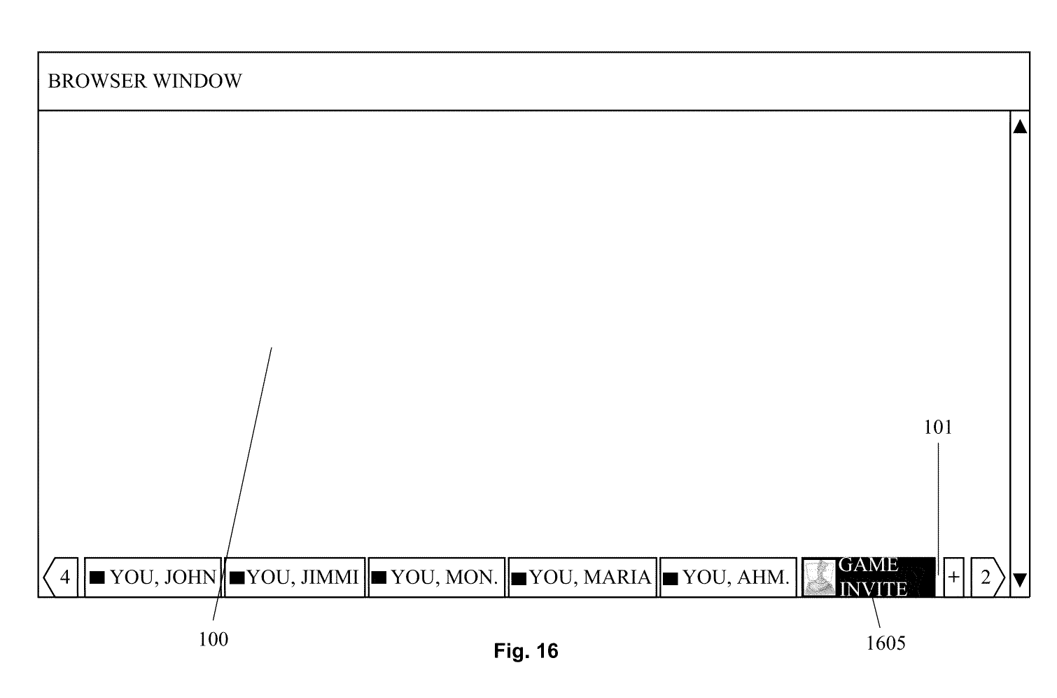

If an online game session needs to alert the user, it does so by changing color as indicated in the game session slot 1605 in FIG. 16. In FIG. 16, it is shown that the game session is inviting the user to join the running game by inverting the color of the game's session slot 1605. It is to be understood that also other types of slots, such as chat slots, also may alert a user if any user activity is requested, e.g., if a user is invited to a chat.

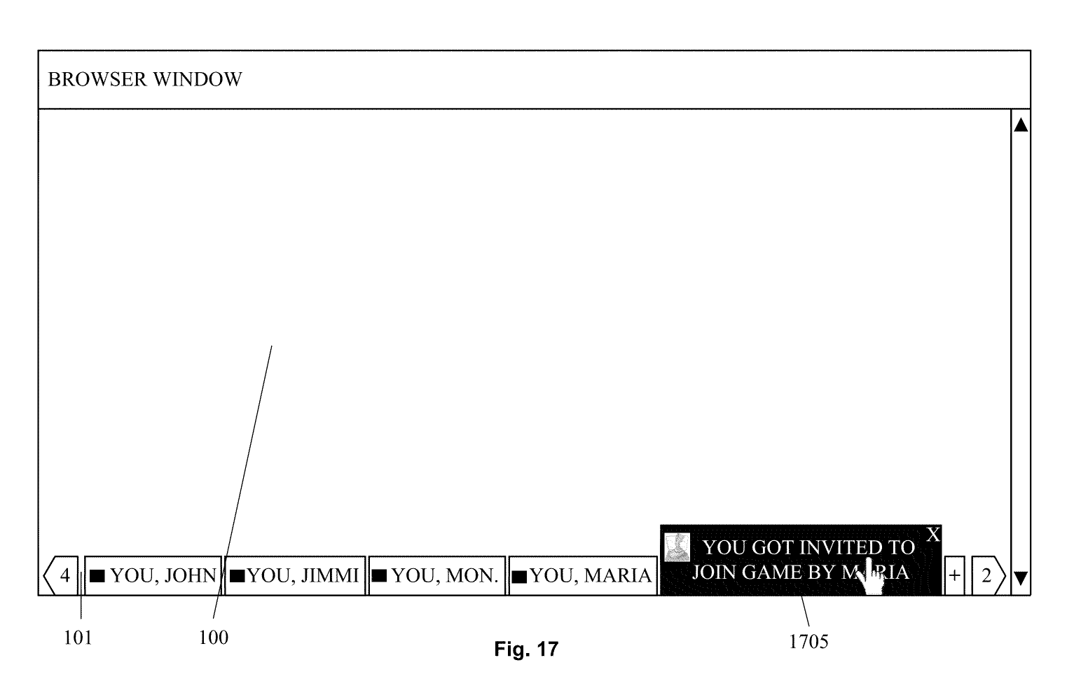

FIG. 17 shows a pointing device hovering over the game session slot 1705, which indicates that the user has been invited to participate in the session. The game session slot increases its size a bit and shows more details, in this case the name of the user who the invitation comes from. It is also to be understood that other types of slots may show additional information and increase in size when a pointing device is hovering over the slot.

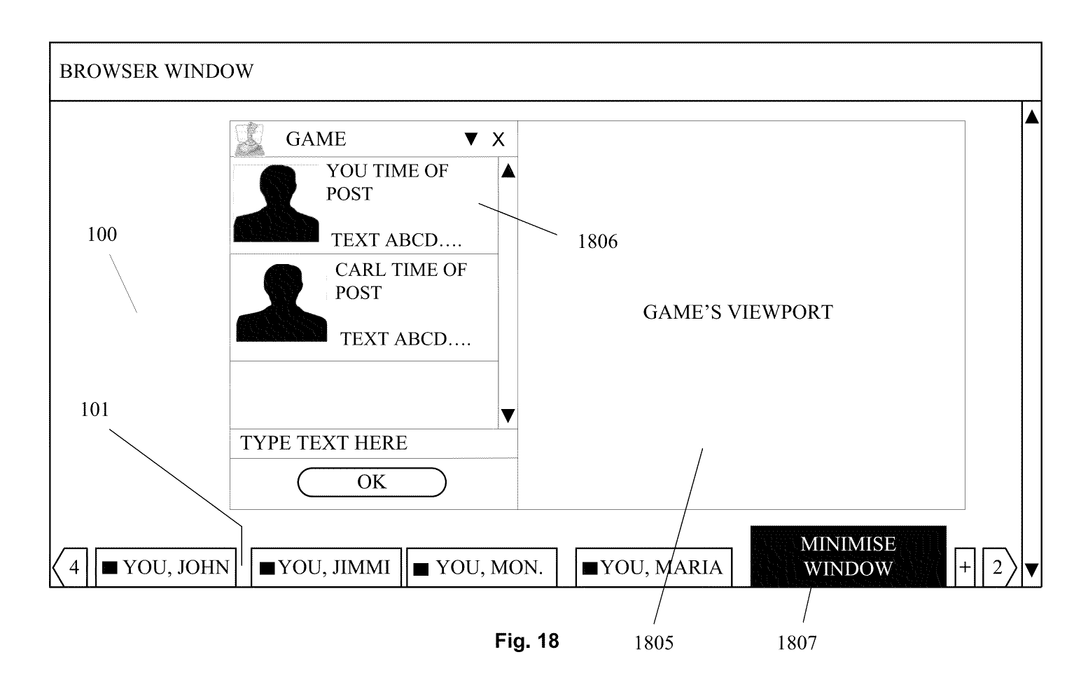

FIG. 18 shows an expanded game session window 1805 on the display field 100. The game session window includes (by default) an attached chat window 1806 with the other players. By clicking on the slot labeled “minimize window” 1807 in the sidebar 101, the game window can be docked again to the sidebar.

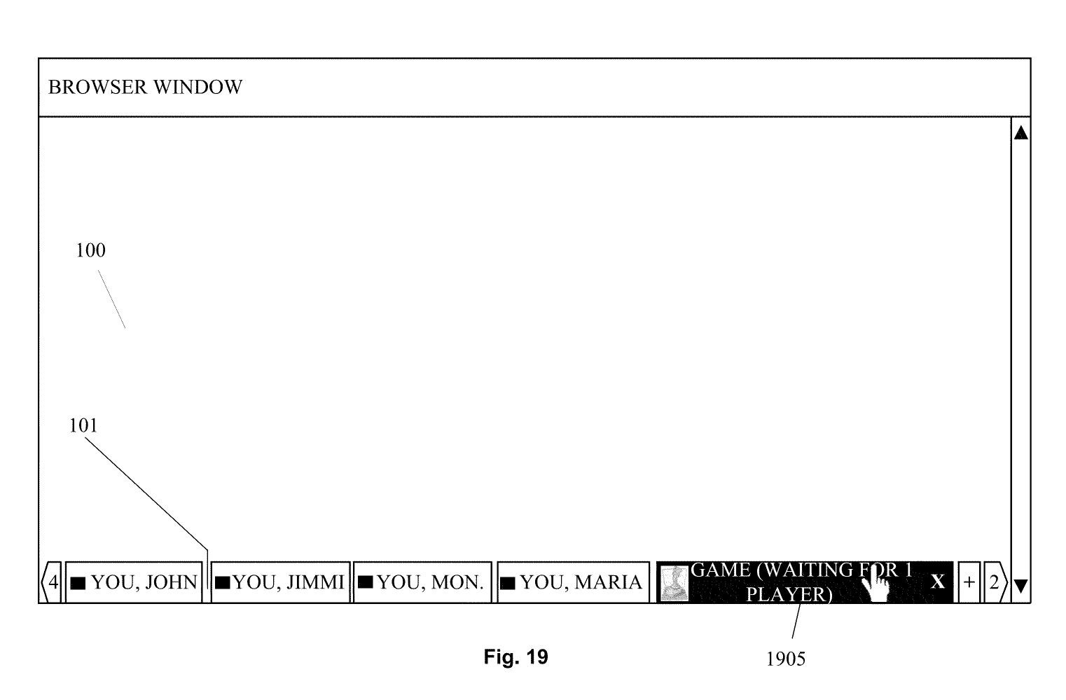

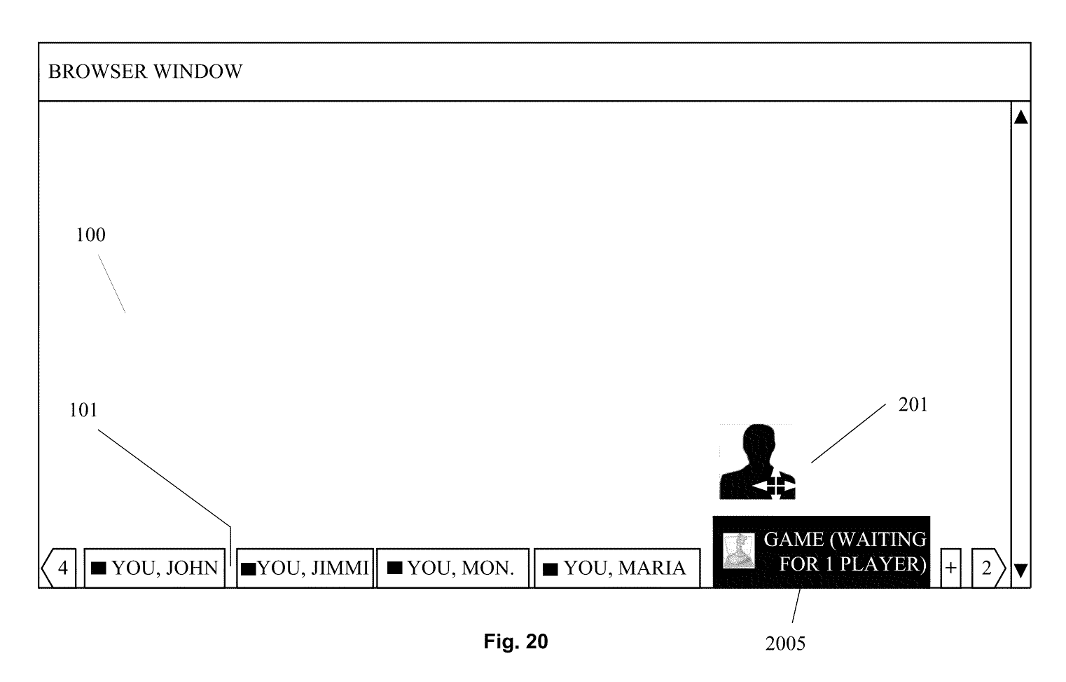

FIG. 19 shows an enlarged game session slot 1905 that is shown in inverted color when hovering the pointing device over the slot. The slot shows additional information about the game session. In this case, it informs the user that one player is missing to start the game by indicating “waiting for 1 player.” The player may be added to the game session by dragging a user's icon 201 into the game session slot as indicated in FIG. 20. The game session slot 2005 is increased in size to indicate that the user icon 201 is allowed to be added to the game session slot.

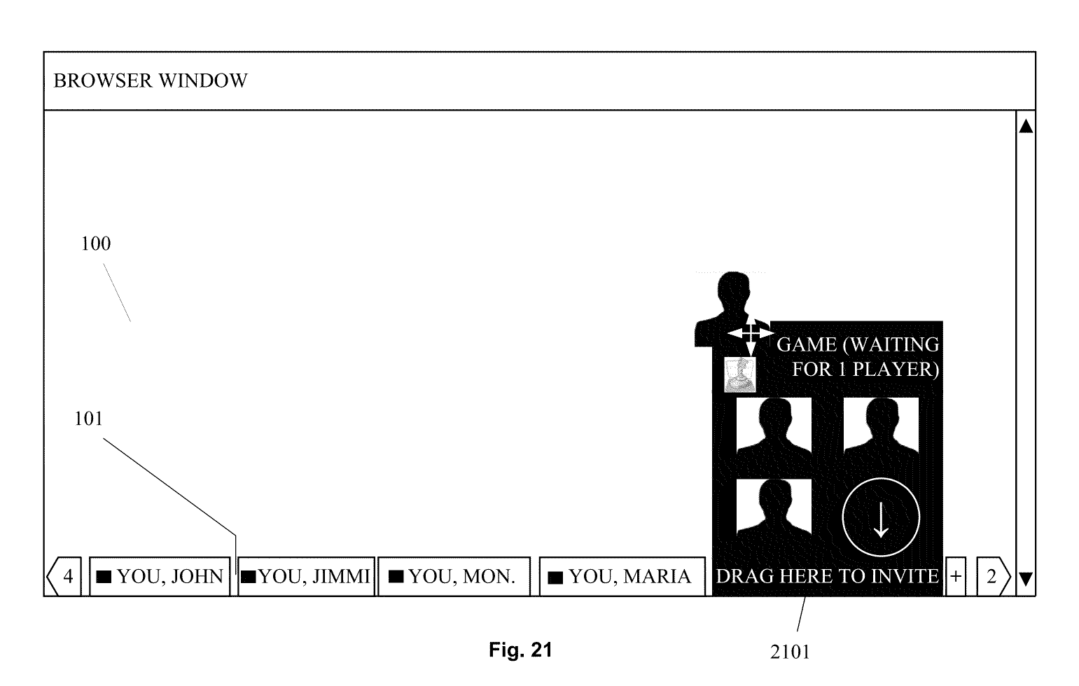

If another user is dragged into the game session, the slot 2101 increases in size, as shown in FIG. 21, and displays the players who are already in the game session, how many open positions it has and, consequently, how many more users are needed to start the game session. In this case, three players are already waiting, while the active user is dragging one more player into the game session to fill it up.

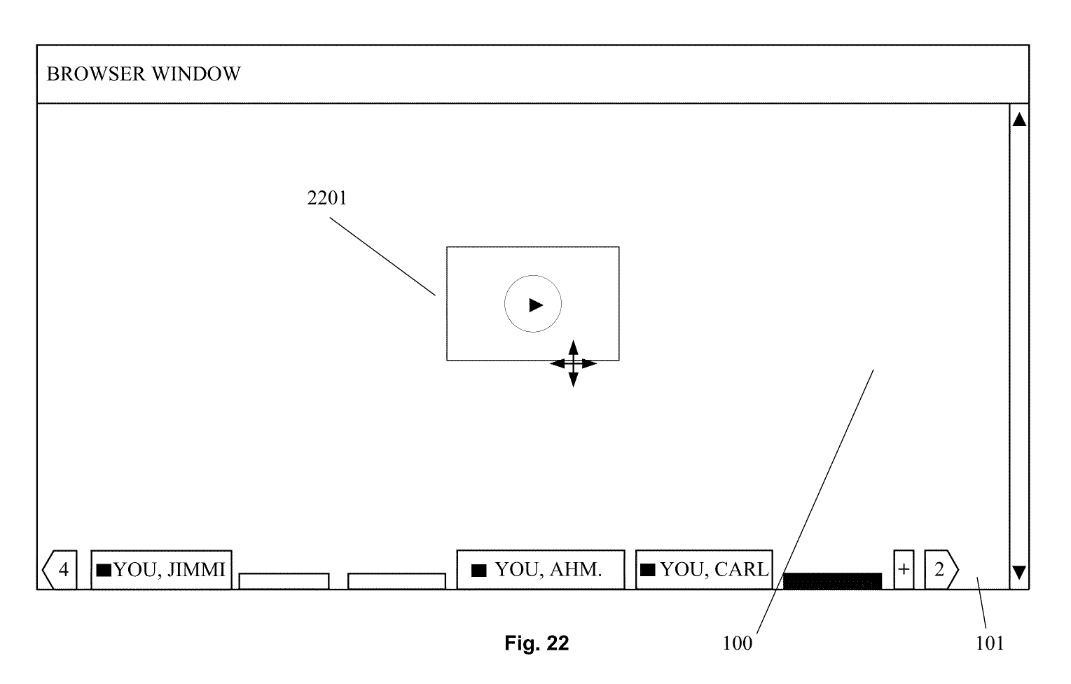

FIG. 22 shows how to drag media content into the sidebar. Just as with the user icons, the user may drag a media content window or icon 2201 into the sidebar. Again, the sidebar hides those slots to which the media content cannot be dragged. The media content may be of different types, such as video, audio, live stream, etc.

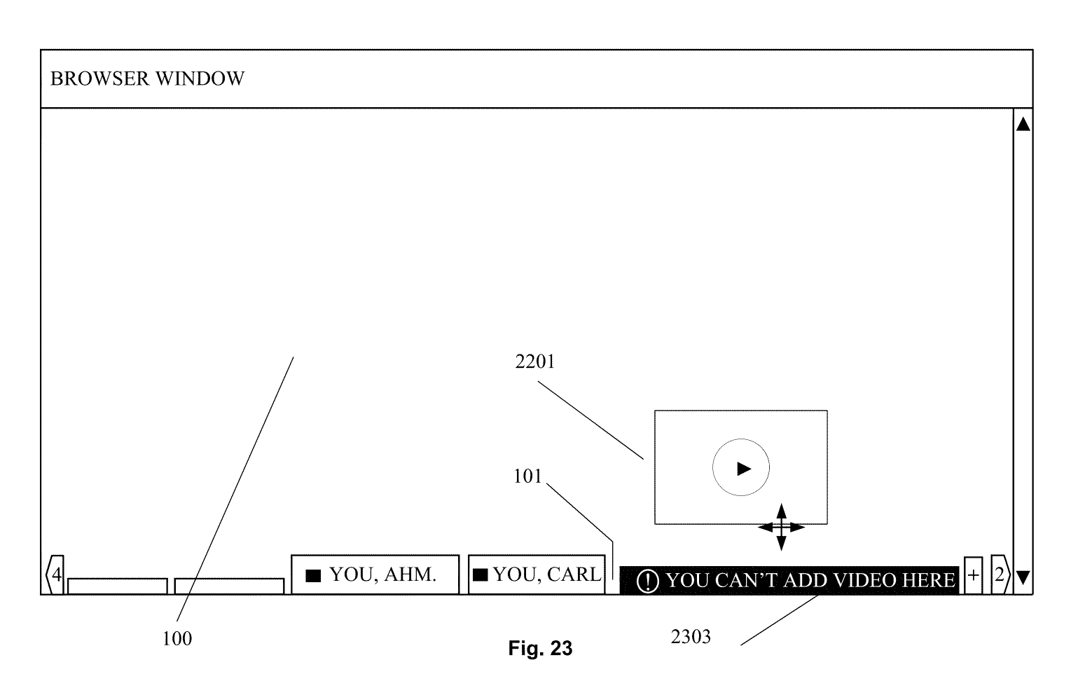

FIG. 23 shows media content that a user tries to drag to a slot where it cannot be dropped. The sidebar informs the user by showing a warning in the slot 2303. In this example, the user cannot drop the media content window 2201 into a slot 2303 of a text chat.

While the representative embodiments have been described in detail, it is to be understood that aspects of the invention can take many forms. The embodiments shown herein are intended to illustrate, rather than to limit the invention as defined by the claims.

The embodiments of the invention in which an exclusive property or privilege is claimed are defined as follows:

1. In a computer system having a user input device, a display device, and at least one interface for connecting the computer system to a computer network, a method of displaying a sidebar in a browser window, said method comprising the steps of:
displaying a browser window on the display device, wherein said browser window is adapted to display live content received from said network and current activities of a user in relation to said live content;
detecting user input in relation to the displayed live content and/or activity, wherein the user input includes dragging the live content and/or current activity from the browser window and dropping it into at least one slot of a sidebar of said browser window;
creating a new slot associated with a current activity to be displayed on said sidebar, if the current activity was dropped into a dedicated slot of the sidebar;
displaying the new slot on the sidebar;
tracking changes inside the activity associated with an existing slot;
modifying the existing slot in the sidebar based on changes inside the activity associated with the existing slot; and
displaying the modified slot in said sidebar.

2. The method of claim 1, wherein said user's activity includes at least one of text chats, video chats, online or offline game sessions, notification applications, and media content playback applications.

3. The method of claim 1, wherein said live content includes at least one of media content received via the network, notifications received via the network, and icons of users connected to the network.

4. The method of claim 1, wherein if the user input includes dragging live content from the browser window and dropping it into an existing slot in the sidebar, then the method further comprises adding the online content to the activity associated with said existing slot.

5. The method of claim 4, wherein if the user input includes dragging an icon associated with another user connected to said network from said browser window and dropping it into an existing slot in said sidebar associated with a text chat, video chat, or an online game session; then the method further includes sending a notification via the network to the other user to be invited to said text chat, video chat, or online game session, respectively.

6. The method of claim 1, further comprising:
displaying an expanded slot when said slot is selected by a user's input.

7. The method of claim 1, further comprising:
displaying a minimized slot when an icon connected to said slot is selected by a user's input.

8. The method of claim 1, further comprising scrolling in a plurality of slots of said sidebar when an icon on at least one end of said sidebar is selected by a user's input.

9. The method of claim 8, further comprising:
displaying a number in said icon on at least one end of the sidebar including a number of hidden slots on said end of said sidebar.

10. The method of claim 9, further comprising:
displaying a number in said icon on said at least one end of the sidebar indicating a number of new messages received in any of the activities and/or live contents associated with all hidden slots at said end of the sidebar.

11. The method of claim 1, further comprising;
displaying a number in a slot indicating a number of new messages received in the activity associated with said slot and not yet being displayed on the browser window.

12. The method of claim 1, further comprising:
displaying an enlarged slot when the user input includes moving a pointing device over said slot.

13. The method of claim 1, further comprising:
displaying information about an activity associated with a slot when the user input includes hovering a pointing device over said slot.

14. The method of claim 13, wherein said information includes users participating in a chat or game session associated with said slot.

15. The method of claim 1, further comprising:
displaying an activity associated with a slot in an expanded window when the user input indicates selection of said slot displayed in the sidebar.

16. The method of claim 1, further comprising:
hiding slots of the sidebar where the selected activity or content cannot be docked.

17. The method of claim 16, further comprising:
displaying a warning in a slot of the sidebar where the selected activity or content cannot be docked.

18. The method of claim 1, further comprising:
if a user's action is requested by an activity associated with a slot displayed in the sidebar, highlighting said slot in the sidebar.

19. A computer-readable storage medium having stored thereon a computer program including computer-readable instructions that, when executed on a computer system, performs the method of claim 1.
